(19) United States
(12) Patent Application Publication
(10) Pub. No.: US 2010/0228478 A1
(43) Pub. Date: Sep. 9, 2010

(54) APPARATUS AND METHOD FOR RECEIVING MAP DATA IN PORTABLE TERMINAL

(75) Inventor: Seung-Hwan YOU, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/716,464

(22) Filed: Mar. 3, 2010

(30) Foreign Application Priority Data
Mar. 4, 2009 (KR) 10-2009-0018313

(51) Int. Cl. G01C 21/36

(52) U.S. Cl. 701/209; 701/208

(57) ABSTRACT

A portable terminal and method for a navigation service for providing MAP data of an area where a real-time connection to a server providing MAP data cannot be performed sufficient to receive the MAP data by the portable terminal in real time. The navigation service typically utilizes satellite signal information. The apparatus includes a shadow area determination unit for determining whether the portable terminal has entered or is entering a shadow area where data communication cannot be performed (i.e. service disabled area), and a controller for requesting MAP information for a specific section to a server providing MAP data when it is determined that the portable terminal enters the shadow area, and for receiving MAP data corresponding to the request from the server.

### CLAIM OF PRIORITY

This application claims the benefit under 35 U.S.C. §119(a) from a Korean patent application filed in the Korean Intellectual Property Office on Mar. 4, 2009 and assigned Serial No. 10-2009-0018313, the entire disclosure of which is hereby incorporated by reference in its entirety.

### BACKGROUND OF THE INVENTION

1. Field of the Invention

The present invention relates to a portable terminal for providing a navigation service. More particularly, the present invention relates to an apparatus and method for a navigation service for a portable terminal that provides MAP by using satellite signal information.

2. Description of the Related Art

Portable terminals are now in widespread use due to the convenience of portability and the increased functionality of such devices. To keep up with such a trend, service providers and terminal manufacturers are competitively developing portable terminals having even more convenient functions in order to attract more users.

For example, the portable terminal provides various functions such as phonebooks, games, schedulers, short message services, multimedia message services, broadcast message services, Internet services, e-mails, wake-up calls, MPEG Layer 3 (MP3) players, digital cameras, just to name a few functions.

In addition, the portable terminal may receive a satellite signal in addition to RF signals, with the satellite signal providing traffic information by accessing a traffic information center through a mobile communication network or to provide a navigation function for providing a user with information on a specific route.

Unlike a typical navigation system, which displays a current position of a moving object by receiving a satellite signal in a state where MAP data is already stored, the navigation function provided by the portable terminal receives and stores MAP data by performing a call connection on a real-time basis to a server providing MAP data whenever there is a change in the current position of the portable terminal. This navigation function operates in this manner because a large capacity of MAP data cannot be stored in a limited memory of the portable terminal.

Therefore, the portable terminal that provides the aforementioned navigation service has to be able to communicate with the server providing the MAP data. When the portable terminal moves to a shadow area where communication to the server is impossible, the portable terminal unable to communicate with the server, and thus the MAP data cannot be received.

Accordingly, there is a need for providing an apparatus and method for receiving MAP data by a portable terminal on a real-time basis in a shadow area wherein a service connection for receiving MAP is lost/degraded.

### SUMMARY OF THE INVENTION

An exemplary aspect of the present invention is to provide an apparatus and method for receiving MAP data of a portable terminal that receives the MAP data on a real-time basis.

Another exemplary aspect of the present invention is to provide an apparatus and method for receiving MAP data in a portable terminal that receives the MAP data on a real-time basis wherein an area of communication with a server providing MAP data cannot be performed or sustained (i.e. a service-disabled area).

Yet another exemplary aspect of the present invention is to provide an apparatus and method in which a portable terminal that receives MAP data on a real-time basis receives MAP data of a specific area before the portable terminal enters an area where communication to a server providing MAP data cannot be performed sufficient to receive the MAP data.

Still another exemplary aspect of the present invention is to provide an apparatus and method for transmitting MAP data of a shadow area to a portable terminal when a server providing MAP data on a real-time basis determines that the portable terminal has moved or is within the shadow area.

In accordance with an exemplary aspect of the present invention, an apparatus for receiving MAP data in a portable terminal is provided. The apparatus preferably includes a shadow area determination unit for determining whether the portable terminal has entered or is entering a shadow area where data communication cannot be performed sufficient to receive the MAP data, and a controller for requesting MAP information for a specific section to a server providing MAP data when there is a determination that the portable terminal entered or is in entering the shadow area, and for receiving MAP data corresponding to the request from the server.

An apparatus according to the present invention preferably includes:

a shadow area determination unit for determining whether the portable terminal has entered or is entering a shadow area wherein data communication cannot be performed sufficient to receive MAP data by the portable terminal; and

a controller for requesting MAP information for a specific section to a server providing MAP data when it is determined that the portable terminal has entered or is entering the shadow area, and for receiving MAP data corresponding to the request from the server.

In a preferred aspect of the invention, the determination unit determines that that the data communication cannot be performed sufficient to receive the MAP data in real-time.

In another preferred aspect of present invention, the determination unit determines the portable terminal is a predetermined distance from the shadow area and moving in a direction toward the shadow area.

In accordance with yet another exemplary aspect of the present invention, a method of receiving MAP data in a portable terminal is provided. The method preferably includes determining whether the portable terminal has entered or is entering a shadow area where data communication for receiving MAP data cannot be performed sufficient to receive the MAP data, requesting MAP information for a specific section to a server providing MAP data when there is a determination that the portable terminal has entered or is entering the shadow area, and receiving MAP data corresponding to the request from the server.

### BRIEF DESCRIPTION OF THE DRAWINGS

The above and other exemplary aspects, features and advantages of certain exemplary embodiments of the present invention will become more apparent from the following detailed description taken in conjunction with the accompanying drawings, in which:

FIG. 1 is a block diagram illustrating a structure of a portable terminal that receives MAP data in a service-disabled area according to an exemplary embodiment of the present invention;

FIG. 2 is a flowchart illustrating an exemplary operational process of receiving MAP data in a portable terminal according to an exemplary embodiment of the present invention;

FIG. 3 is a flowchart illustrating an exemplary operational process of receiving MAP data in a portable terminal according to an exemplary embodiment of the present invention;

FIG. 4 is a flowchart illustrating exemplary operation of a server providing the MAP data according to an exemplary embodiment of the present invention;

FIG. 5A illustrates a scenario wherein a portable terminal moves to a shadow area according to an exemplary embodiment of the present invention; and

FIG. 5B illustrates a section for receiving MAP data in a portable terminal according to an exemplary embodiment of the present invention.

### DETAILED DESCRIPTION

The following description, with reference to the accompanying drawings, is provided to assist in a comprehensive understanding of certain exemplary embodiments of the invention provided herein for illustrative purposes. The description includes various specific details to assist a person of ordinary skill the art with understanding the claimed invention, but these details are to be regarded as merely exemplary. Accordingly, those of ordinary skill in the art will recognize that various changes and modifications of the illustrative examples described herein can be made without departing from the spirit of the invention and the scope of the appended claims. Also, descriptions of well-known functions and constructions may be omitted for clarity and conciseness when their inclusion may obscure appreciation of the subject matter of the claimed invention by a person or ordinary skill in the art.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

The present invention described hereinafter relates to an apparatus and method for receiving MAP data of an area where communication to a server providing MAP data cannot be performed sufficient to receive the MAP data by a portable terminal that receives the MAP data on a real-time basis.

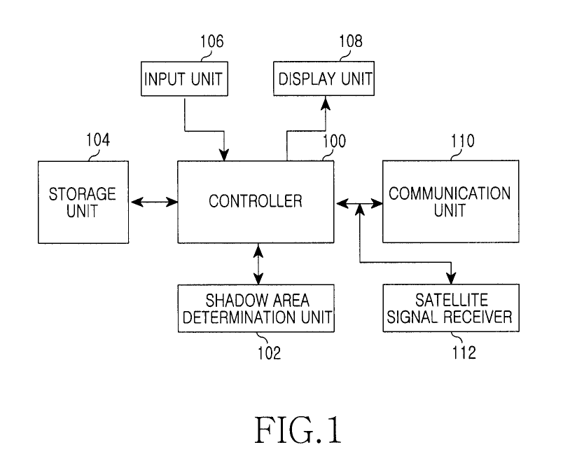

FIG. 1 is a block diagram illustrating a structure of a portable terminal that receives MAP data in a service disabled area according to an exemplary embodiment of the present invention.

Referring now to the example shown FIG. 1, an exemplary portable terminal according to the present invention preferably includes, for example, a controller 100, a shadow area determination unit 102, a storage unit 104, an input unit 106, a display unit 108, a communication unit 110, and a satellite signal receiver 112.

The controller 100 provides overall control to the portable terminal. For example, the controller 100 processes and controls voice calls and data communications, receives MAP data from a server providing MAP data when a navigation service is provided, and then performs the service. In addition to the typical functions, according to the present invention, if the controller determines that the portable terminal enters a shadow area where communication to the server providing MAP data is impossible, the controller 100 then controls such that MAP data of an area having a specific range is requested by communicating with the server before (prior) to entering the shadow area.

Accordingly, under the control of the controller 100, MAP data of the shadow area is stored prior to the portable terminal entering the shadow area, and thus even if the portable terminal enters the shadow area, the navigation service is persistently provided by using MAP data received before the portable terminal enters the shadow area. When determining whether the portable terminal has entered the shadow area, the controller 100 may control the shadow area determination unit 102 to compare received signal strength with a threshold required for determining whether the portable terminal has entered into the shadow area.

Under the control of the controller 100, the shadow area determination unit 102 determines whether the portable terminal has moved to an area where communication to the server providing MAP data cannot be performed (i.e. a service-disabled area). For example, the shadow area determination unit 102 may measure received signal strength, and an area where the measured received signal strength is relatively lower than other areas may be determined to be the shadow area where communication to the server for receiving MAP data cannot be performed sufficient to receive the MAP data on a real-time basis, for example.

The storage unit 104 preferably includes, for example, a Read Only Memory (ROM), a Random Access Memory (RAM), and a flash ROM. The ROM stores a microcode of a program, by which the controller 100 and the shadow area determination unit 102 are processed and controlled, and a variety of reference data.

The RAM is a working memory of the controller 100 and stores temporary data that is generated while programs are performed. The flash ROM stores rewritable data, such as phonebook entries, outgoing messages, incoming messages, and information of user touch input points, and stores MAP data provided from the server according to the present invention.

The input unit 106 preferably includes a plurality of function keys such as numeral key buttons of ‘0’ to ‘9’, a menu button, a cancel (or delete) button, an OK button, a talk button, an end button, an Internet access button, a navigation (or direction) key button, a character input key, and the like. Key input data, which is input when the keys are pressed, is provided to the controller 100.

The display unit 108 displays information such as status information, which is generated while the portable terminal operates, limited numeral characters, large-sized moving and still pictures, and the like. The display unit 108 may be a color Liquid Crystal Display (LCD). When the display unit 108 is equipped with a touch input device and thus is applied to a touch input type portable terminal, the display unit 108 may also be used as an input device for some or all input items.

With continued reference to FIG. 1, the communication unit 110 transmits and receives a Radio Frequency (RF) signal of data that is input and output through an antenna (not shown). For example, in a transmitting process, data to be transmitted may be subject to, for example, a channel-coding process and a spreading process, and then the data is transformed to an RF signal. In a receiving process, the RF signal is received and transformed to a base-band signal, and depending on the protocol used the base-band signal can be subject to a de-spreading process and a channel-decoding process, thereby restoring the data. Further, a message for requesting MAP data is transmitted to the server, and the requested MAP data is received from the server.

The satellite signal receiver 112 receives a satellite signal for determining a position of the portable terminal.

Although a function of the shadow area determination unit 102 can be performed by the controller 100, the shadow area determination unit 102 and the controller 100 preferably are separately constructed in the present invention for exemplary purposes only. Thus, those ordinary skilled in the art can understand that various modifications can be made within the scope of the present invention. For example, functions of the shadow area determination unit 102 and the controller 100 may be integrally processed by the controller 100.

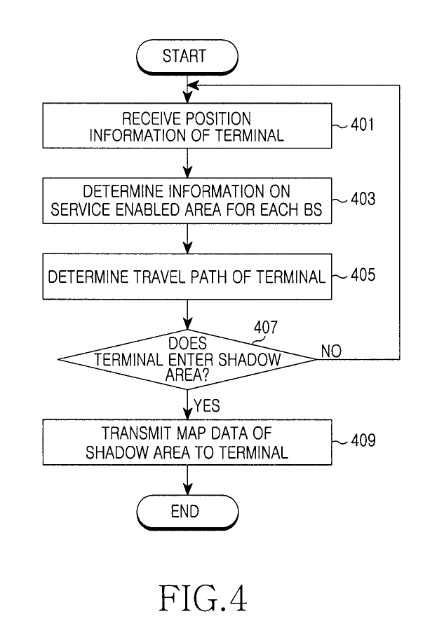

Although an apparatus for receiving MAP data of a shadow area where communication to the server cannot be performed sufficient to receive the MAP data by the portable terminal has been described above, the server providing MAP data that may determine a travel section of the portable terminal, and when the portable terminal is moving toward the shadow area, the server may transmit MAP data of the shadow area to the portable terminal prior to the portable terminal reaching a position where the communication cannot be sustained. An exemplary operation of the server providing MAP data will be described below in detail with reference to the flowchart of FIG. 4.

An apparatus for receiving MAP data of an area where communication to a server providing MAP data cannot be performed sufficient to receive the MAP data by a portable terminal that receives MAP data on a real-time basis according to the present invention has been described above. In the following description, a method for allowing persistent MAP data reception in a portable terminal that receives MAP data on a real-time basis by receiving MAP data of a specific area before the portable terminal enters an area where communication to a server providing MAP data cannot be performed sufficient to receive the MAP data will now be described by using the aforementioned apparatus according to an exemplary embodiment of the present invention.

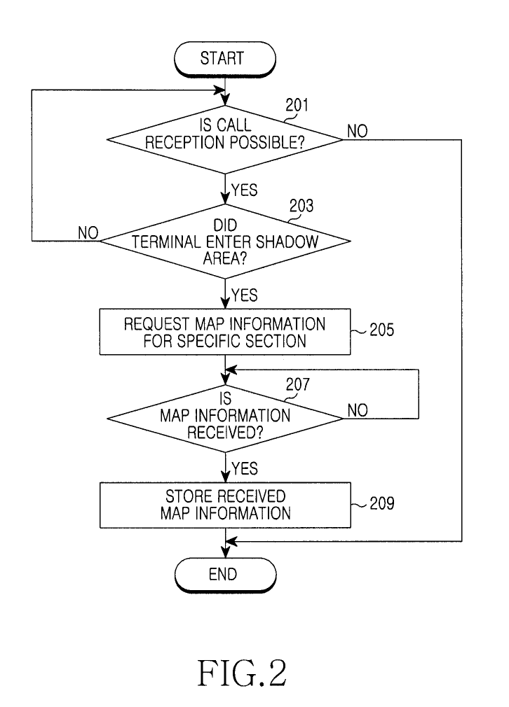

FIG. 2 is a flowchart illustrating an exemplary process of receiving MAP data in a portable terminal according to an exemplary embodiment of the present invention.

Referring now to FIG. 2, at step 201, there is a determination as to whether or the portable terminal is positioned in an area where call reception is possible (can be performed sufficient for the portable terminal to receive the transmission successfully).

If it is determined in step 201 that the call reception cannot be performed sufficient for the portable terminal to receive the MAP data, the procedure of FIG. 2 ends.

However, if it is determined in step 201 that the call reception by the portable terminal can be performed, proceeding step 203, it is determined whether the portable terminal entered into a shadow area. In this step, it is determined whether the portable terminal has entered the shadow area, where reception of MAP information cannot be performed.

If it is determined in step 203 that the portable terminal did not enter the shadow area, the process of step 201 is repeated.

If it is determined in step 203 that the portable terminal has entered the shadow area, proceeding to step 205, MAP information for a specific section is requested to a server providing MAP information, and then proceeding to step 207, it is determined whether the requested MAP information for the section is received from the server providing MAP information.

If the requested MAP information on the section is not received in step 207, the process of step 207 is repeated.

If the requested MAP information on the section is received in step 207, proceeding to step 209, the received MAP information is stored, and then a navigation service is provided by using the received MAP information.

Accordingly, the portable terminal can persistently provide the navigation service for receiving MAP data on a real-time basis even in an area where call reception is impossible. A person of ordinary skill in the art should understand that, for example, based on a reduced level of transmission strength received by the portable terminal can be a basis for determining that the portable terminal has entered or is about to enter a portion of the shadow area where communication service will become disabled with continued movement into the shadow area, and the portable terminal requests the MAP information for the shadow area prior to a loss of communication necessary for successful receipt thereof. In addition, there can be a determination that the portable terminal is within a predetermined distance from the shadow area such that movement in the direction toward the shadow area will result in a loss of communication (“service-disabled area”). Thus, the term “has entered or is entering the shadow area” encompasses the aforementioned.

Thereafter, the procedure of FIG. 2 ends.

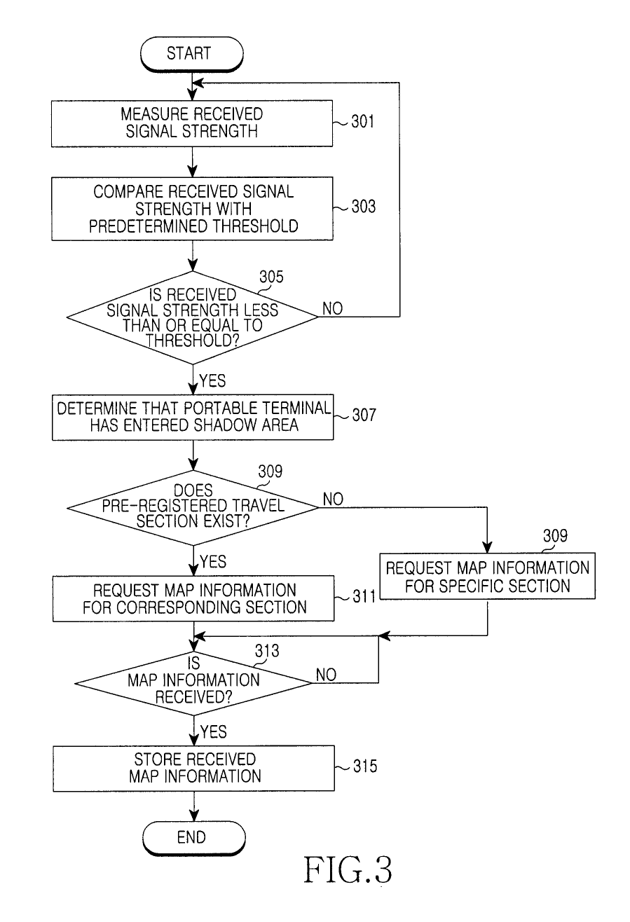

FIG. 3 is a flowchart illustrating an exemplary process of receiving MAP data in a portable terminal according to another exemplary embodiment of the present invention.

Referring now to FIG. 3, received signal strength is measured in step 301.

In step 303, the received signal strength measured in step 301 is compared with a predetermined threshold. The predetermined threshold is a value for determining whether the portable terminal has entered into a shadow area. For example, there can be a determination that the portable terminal enters the shadow area when the received signal strength is less than or equal to the threshold. The threshold may be set to a value greater than received signal strength capable of receiving the MAP data or received signal strength capable of allowing a handover process.

If it is determined in step 305 that the received signal strength is greater than the threshold, it is determined that the portable terminal did not enter the shadow area, and then the process of step 301 is repeated.

If it is determined in step 305 that the received signal strength is less than or equal to the threshold, proceeding to step 307, it is determined that the portable terminal has entered is or entering the shadow area where reception of the MAP data cannot be performed.

That is, the received signal strength is measured in order to determine whether the portable terminal is entering the area where reception of the MAP data cannot be performed, and if the measured received signal strength is less than or equal to the threshold, it can be determined that the portable terminal is moving to the shadow area.

When it is determined that the portable terminal is currently moving to the shadow area, proceeding to step 309, it is determined whether a travel section (e.g., a destination place, a transit place (both of which can be referred to as a “location”), and the like which are determined when using a navigation service) has been pre-registered or selected by a user of the portable terminal.

If it is determined in step 309 that the pre-registered travel section does not exist, proceeding to step 317, MAP data of a specific section is requested from a server providing MAP data. For one example, the portable terminal may request from the server providing MAP data to send MAP data of an area having a radius of 10 km around a place where the portable terminal is positioned. For another example, the requested MAP data may be in association with a section of 10 km around a place on a road where the portable terminal is positioned. For another example, if the shadow area is a tunnel, the requested MAP data may be in associated with a radius of 10 km or a road section of 10 km from a place where the portable terminal is positioned after passing the tunnel. Therefore, the user can pre-recognize the MAP after passing through the tunnel without having to receive MAP data regarding the inside of the tunnel, which overcomes the issue in the conventional method where there would not be successful reception of map data in the tunnel.

A person of ordinary skill in the art should understand and appreciate that the value of 10 km is only provided for explanatory purposes, and values substantially larger or smaller than 10 Km can be used.

If it is determined in step 309 that the pre-registered travel section exists, proceeding to step 311, MAP data of the section, that is, a section between a current place to a destination pre-registered in the portable terminal is requested from the server by the portable terminal.

After requesting the MAP data from the server, proceeding to step 313, it is determined whether the MAP data requested to the server has been received. If it is determined in step 313 that the requested MAP data has not been received from the server, the process of step 313 is repeated until the MAP data is received.

If it is determined in step 313 that the MAP data has been received from the server, proceeding to step 315, the MAP data received from the server is stored.

Accordingly, even in a situation where MAP data cannot be received from the server, that is, even if the portable terminal enters the shadow area where a connection to the server is cannot be performed sufficient to receive the MAP data, the portable terminal can provide a navigation service by using MAP data received and stored in advance of entering the shadow area.

Thereafter, the procedure of FIG. 3 ends.

FIG. 4 is a flowchart illustrating an example of an operation of a server providing MAP data according to an exemplary embodiment of the present invention.

Referring now to FIG. 4, position information of a portable terminal is received in step 401. This position information is provided for determining a movement of the portable terminal. The server may receive the information either from the portable terminal or from a Base Station (BS) in a cell where the portable terminal is located.

In step 403, information on a service enabled area is received and determined for all BSs. In step 405, a travel path of the portable terminal is determined.

In step 407, there is a determination as to whether or not the portable terminal has entered a shadow area is determined.

In this case, the server is in a state where information on an area capable of providing a service to the BSs is received from the BSs, and thus the server can determine the shadow area where a MAP service cannot be provided. Therefore, according to the travel path of the portable terminal, the server can determine whether the portable terminal moves to the shadow area where MAP data cannot be received.

If it is determined in step 407 that the portable terminal is not moving into the shadow area, the process of step 401 is repeated to determine whether the portable terminal is moving into the shadow area.

If it is determined in step 407 that the portable terminal is moving to the shadow area, proceeding to step 409, MAP data of the shadow area are transmitted to the portable terminal moving to the shadow area.

That is, the server pre-recognizes information on the shadow area and transmits MAP data of the shadow area before (prior to) the portable terminal moves to the shadow area such that communication can not be performed sufficient to receive the MAP data, thereby allowing the portable terminal to be able to provide a navigation service even in the shadow area.

Thereafter, the procedure of FIG. 4 ends.

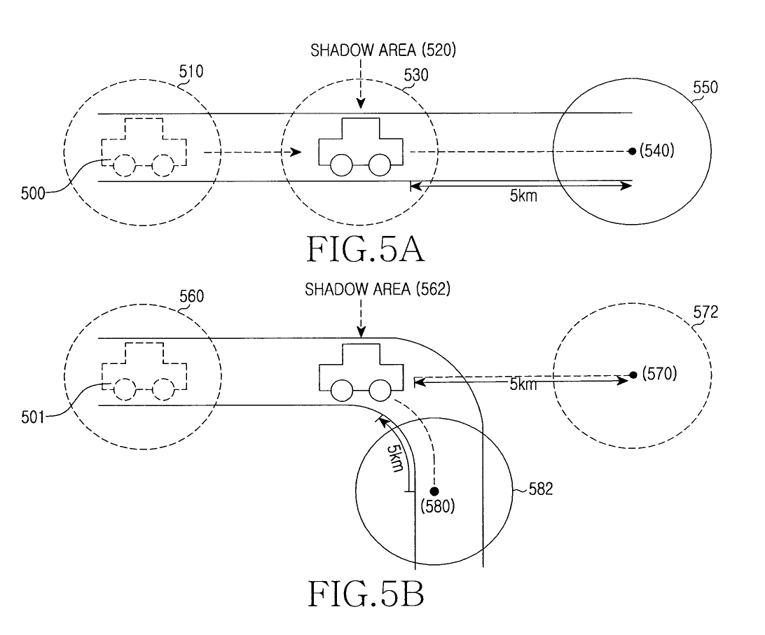

FIGS. 5A and 5B illustrate a process of providing MAP data in a portable terminal according to an exemplary embodiment of the present invention.

FIG. 5A illustrates a situation where a portable terminal moves to a shadow area according to an exemplary embodiment of the present invention.

Referring now to FIG. 5A, a portable terminal 500 is moving on a road along with a vehicle, and receives MAP data of a specific area when entering a shadow area. In this case, the portable terminal may request MAP data of a specific section 510 around a place where the portable terminal is positioned, or may request MAP data of a section separated by a specific distance from the place where the portable terminal is positioned. That is, if the shadow area is a tunnel for example, the portable terminal determines that MAP data of the tunnel is unnecessary, and thus receive MAP data of a section located farther than (beyond) a length of a tunnel section. In other words, when the portable terminal 500 enters a shadow area 520, e.g., a tunnel start section as shown in FIG. 5A, the portable terminal receives MAP data of a specific section 530 around the place where the portable terminal is positioned or receives MAP data of a specific section 550 around a place 540 separated by a distance of 5 km corresponding to a tunnel length.

FIG. 5B illustrates a section for receiving MAP data in a portable terminal according to an exemplary embodiment of the present invention.

Referring now to FIG. 5B, a portable terminal 501 is moving on a road along with a vehicle similarly to FIG. 5A, and receives MAP data of a specific area 560 when entering a shadow area. In this case, unlike in FIG. 5A, the portable terminal receives MAP data of a specific section around a place on a road along which the portable terminal is moving.

For example, if the portable terminal enters a shadow area 562 as shown in FIG. 5B, the portable terminal receives MAP data of a specific section 582 around a place 580 separated by 5 km along a curved road unlike in FIG. 5A in which the portable terminal receives MAP data of a specific sector 572 around a place 570 separated by 5 km.

According to the above-presented exemplary embodiments of the present invention, an apparatus and method for receiving MAP data of an area where communication to a server providing MAP data cannot be performed in a portable terminal that typically receives MAP data on a real-time basis are provided. Therefore, MAP data of a specific area is received in advance before the portable terminal moves to an area where communication to the server is impossible, and thus the MAP data can be persistently used. As a result, a navigation service can be persistently provided.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

The above-described methods according to the present invention can be realized in hardware or as software or computer code that can be stored in a recording medium such as a CD ROM, a RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

What is claimed is:

1. An apparatus for receiving MAP data in a portable terminal, the apparatus comprising:
a shadow area determination unit for determining whether the portable terminal has entered or is entering a shadow area wherein data communication cannot be performed sufficient to receive MAP data by the portable terminal; and
a controller for requesting MAP information for a specific section to a server providing MAP data when it is determined that the portable terminal has entered or is entering the shadow area, and for receiving MAP data corresponding to the request from the server.

2. The apparatus of claim 1, wherein the determination unit determines that the data communication cannot be performed sufficient to receive the MAP data in real-time.

3. The apparatus according to claim 1, wherein the determination unit determines the portable terminal is a predetermined distance from the shadow area and moving in a direction toward the shadow area.

4. The apparatus of claim 1, wherein the controller controls persistently providing a navigation service in the shadow area by storing the received MAP data.

5. The apparatus of claim 1, wherein, if received signal strength is measured to be less than or equal to a predetermined threshold, the shadow area determination unit determines that the portable terminal has entered or is entering the shadow area.

6. The apparatus of claim 5, wherein the predetermined threshold is a value for determining whether the portable terminal has entered or is entering the shadow area, and can be set to a value greater than minimum received signal strength for receiving the MAP data or received signal strength for allowing a handover process.

7. The apparatus of claim 1, wherein, if it is determined that a pre-registered path is established, the controller requests MAP data of the pre-registered path, and if it is determined that the pre-registered path is not established, the controller requests MAP data of an area having a specific radius around a location where the portable terminal is positioned.

8. The apparatus of claim 7, wherein the controller requests MAP data of a specific section around a location on a road where the portable terminal is positioned.

9. The apparatus of claim 7, wherein the controller requests MAP data of an area having a specific radius around a location where the portable terminal is positioned after the portable terminal passes the shadow area or a specific section around a location on a road where the portable terminal is positioned after the portable terminal passes the shadow area.

10. The apparatus of claim 1, wherein, upon receiving a MAP data request from the portable terminal, the server providing MAP data performs a process of transmitting the MAP data corresponding to the request to the portable terminal.

11. The apparatus of claim 1, wherein the server providing MAP data determines the shadow area by receiving information on a service enabled area for each base station, and if whether the portable terminal enters the shadow area is determined by receiving position information of the portable terminal, the server transmits MAP data of the shadow area to the portable terminal prior to data communication cannot be performed sufficient to receive MAP data by the portable terminal.

12. A method of receiving MAP data in a portable terminal, the method comprising:
determining whether or not the portable terminal has entered or is entering a shadow area where data communication cannot be performed sufficient to receive MAP data by the portable terminal;
requesting MAP information for a specific section to a server providing MAP data when it is determined that the portable terminal has entered or is entering the shadow area; and
receiving MAP data corresponding to the request from the server.

13. The method of claim 12, further comprising the portable terminal persistently providing a navigation service in the shadow area by storing the received MAP data.

14. The method of claim 12, wherein the determining step includes determining that the data communication cannot be performed sufficient to receive the MAP data in real-time.

15. The method of claim 12, wherein the determining step includes determining that the portable terminal is a predetermined distance from the shadow area and moving in a direction toward the shadow area.

16. The method of claim 12, wherein the determining of whether the portable terminal has entered or is entering the shadow area where data communication cannot be performed sufficient to receive the MAP data comprises:
measuring received signal strength;
comparing the measured received signal strength with a predetermined threshold; and
if the measured received signal strength is less then or equal to the threshold, determining that the portable terminal has entered or is entering the shadow area.

17. The method of claim 16, wherein the predetermined threshold is a value for determining whether the portable terminal has entered or is entering the shadow area, and can be set to a value greater than minimum received signal strength for receiving the MAP data or received signal strength for allowing a handover process.

18. The method of claim 12, wherein the requesting of the MAP information for the specific section to the server providing MAP data comprises:
determining whether a pre-registered path is established;
if it is determined that the pre-registered path is established, requesting MAP data for the pre-registered path; and
if it is determined that the pre-registered path is not established, requesting MAP data of an area having a specific radius around a location where the portable terminal is positioned.

19. The method of claim 18, wherein the requesting of the MAP information for the specific section to the server providing MAP data comprises requesting MAP data of a specific section around a location on a road where the portable terminal is positioned.

20. The method of claim 18, wherein the requesting of the MAP information for the specific section to the server providing MAP data comprises requesting MAP data of an area having a specific radius around a location where the portable terminal is positioned after the portable terminal passes the shadow area, or a specific section around a location on a road where the portable terminal is positioned after the portable terminal passes the shadow area.

21. The method of claim 12, wherein, upon receiving a MAP data request from the portable terminal, the server providing MAP data performs a process of transmitting the MAP data corresponding to the request to the portable terminal.

22. The method of claim 12, wherein the server providing MAP data further performs steps of:
determining the shadow area by receiving information on a service enabled area for each base station;
determining whether the portable terminal has entered or is entering the shadow area by receiving position information of the portable terminal; and
if it is determined that the portable terminal has entered or is entering the shadow area enters the shadow area, transmitting MAP data of the shadow area to the portable terminal before data communication cannot be performed sufficient to receive MAP data by the portable terminal.
